(19) United States
(12) Patent Application Publication
(10) Pub. No.: US 2010/0106669 A1
(43) Pub. Date: Apr. 29, 2010

(54) Journal Manuscript Submission Decision Support System

(75) Inventor: Gen Ming Guo, Kaohsiung (TW)

Correspondence Address: Gen Ming Guo, 821 Lujhu, P.O. Box 102, Kaohsiung County, 82101, TW

(73) Assignee: Guo Gen Ming

(21) Appl. No.: 12/611,928

(22) Filed: Nov. 3, 2009

Related U.S. Application Data
(63) Continuation-in-part of application No. 11/169,849, filed on Jun. 28, 2005.

(30) Foreign Application Priority Data
Nov. 14, 2008 (TW) 097144224

(51) Int. Cl. G06F 15/18; G06F 17/00; G06N 5/02

(52) U.S. Cl. 706/11; 706/12; 706/46

(57) ABSTRACT

This innovation is to create one journal manuscript submission decision support system. It includes three major subsystems which are Decision Factor Filtering System, Manuscript Submission Decision Support System and Decision Model Verification System. Using on-line questionnaire module can collect and filter the critical decision factors. Through the statistics analysis, the weighted decision factors can be stored on the factor weight model database. After combining with periodical database, the manuscript submission decision support system can generate the ranking journal list which assists author(s) to submit their research papers to the suitable academic journal. The decision model verification system will apply Technology Acceptance Model (TAM) to verify the usefulness and easy-to-use of this Journal Manuscript Submission Decision Support System. The decision model can be fine-tuned by verification system in order to become reliable and trusted model. The critical decision factors can be filtered out. Finally, it can reduce authors' time to look for suitable journal when they must choose from a large number of periodicals to submit their manuscript.

### CROSS REFERENCES TO RELATED APPLICATION

This application is a continuation-in-part of U.S. application Ser. No. 11/169,849, filed Jun. 28, 2005, U.S. application Ser. No. 9/885,926, filed Jun. 22, 2001. These applications are incorporated herein by reference in its entirety.

### FIELD OF THE INVENTION

The present invention pertains to the field of computer software. More specifically, the present invention relates to one kind of decision support system to help author to select and filter suitable academic journal from more than ten thousands of journals in order to submit their manuscripts. This system can generate and provide one recommended journal list which takes account of different author's preferences.

### BACKGROUND OF THE INVENTION

It is generally at the academia field for professor, faculty, graduate student or researcher etc. to publish and unveil their innovation or discovery on the academic journal. Each journal has its own features, audiences, policies and focuses. Therefore, authors must survey and learn more about different journals which would be close to their research subject field. If authors don't survey this well, the reject rate would increase. And then it would initiate another turn-around trip for the manuscript. Currently, the peer review, revision or rejection processes often took a long period of time in real world. How to choose the suitable journal to submit becomes critical issue in order to reduce the reject rate and save paper-trip time.

At least ten thousands of journals published in the world. It was impossible for author to screen all journals. And most authors' choice and decision were limited to personal cognitions. Editor-in-chief and editorial board members sometimes change the journal title or collection subjects after several years. Take full advantage of software system, it can detect these changes and recalculate paper keyword frequency. It can provide up-to-date information and intelligence for scholars. If authors can get the latest intelligence about journals, they could make the better decision when they have to choose one journal to submit their manuscript.

### SUMMARY OF THE INVENTION

One manuscript submission decision support system was designed in this research. It was designed to help scholars to choose suitable journals in order to submit their manuscripts. That was because scholars have difficult to recognize and remember too much journals. After authors submit their paper in this manuscript submission support system, the manuscript submission management subsystem can assist registered users to maintain their submission status or history record. Manuscript submission decision support system can exchange data with general online paper submission and peer-reviewed system via manuscript submission management subsystem.

Decision Factor Filtering System was designed to filter key variables which most authors consider them. Through Basic Decision Factor On-line Questionnaire Module and AHP Decision Factor On-line Questionnaire Module, different factors would be collected and ranked. Both Statistic and AHP (Analytic Hierarchy Processing) were used to calculate the decision factor weight. Those factor weights were saved in Factor Weight Model DB.

Manuscript Submission Decision Support System not only gets the users' preferences from on-line GUI (Graphic User Interface) but also get the Factor Weights from Factor Weight Model DB. There are four key steps in this system. They are intelligence, design, choice and implementation steps. Several key factors would be calculated such as article language, indexed DB, journal classification, journal impact factor, article amount of specific subject in journal and so on.

Decision Model Verification System was designed to verify the proposed model in this research. The Technology Acceptance Model (TAM) was used here. There are three key parts in TAM model; 1) Easy to Use; 2) Usefulness; 3) Accuracy. Through this system, the new model could be evaluated and fine tuned in order to increase its reliability and validity. In this way, Decision Model Verification System can be fit to users' requirement more.

### BRIEF DESCRIPTION OF DRAWINGS

FIG. 1 is a diagram of the whole system architecture including 3 subsystems.

FIG. 2 is a diagram of the Decision Factor Filtering System.

FIG. 3 is a diagram of the Manuscript Submission Decision Support System.

FIG. 4 is a diagram of Decision Model Verification System.

### DETAILED DESCRIPTION

In order to reveal the technology used in this research, the further disclosures such as innovation purpose, system function and so on, would be described in the following section. The related figures would be explained.

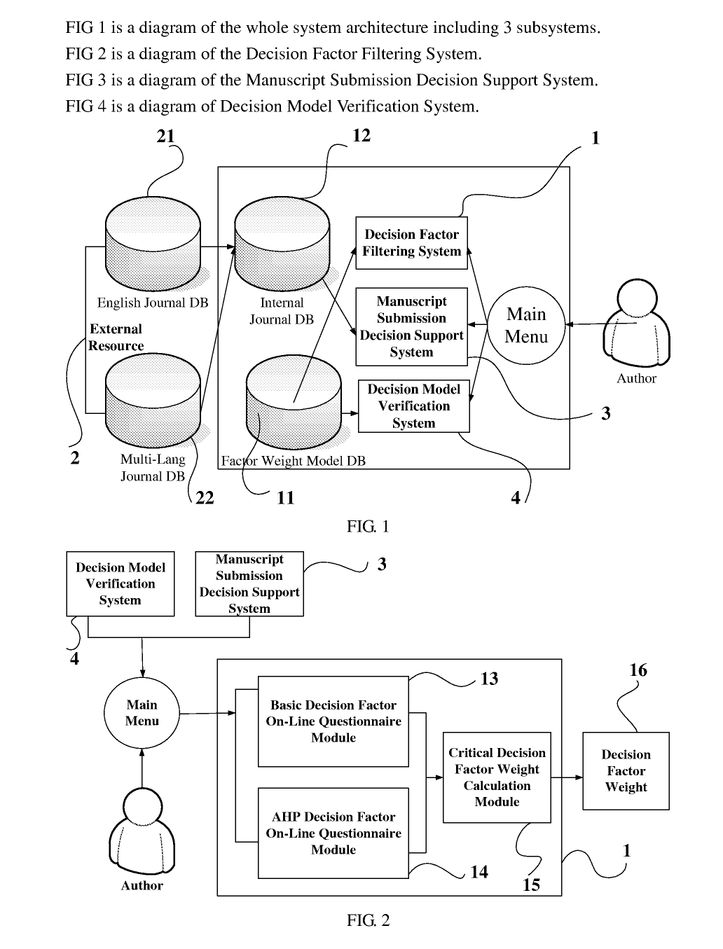

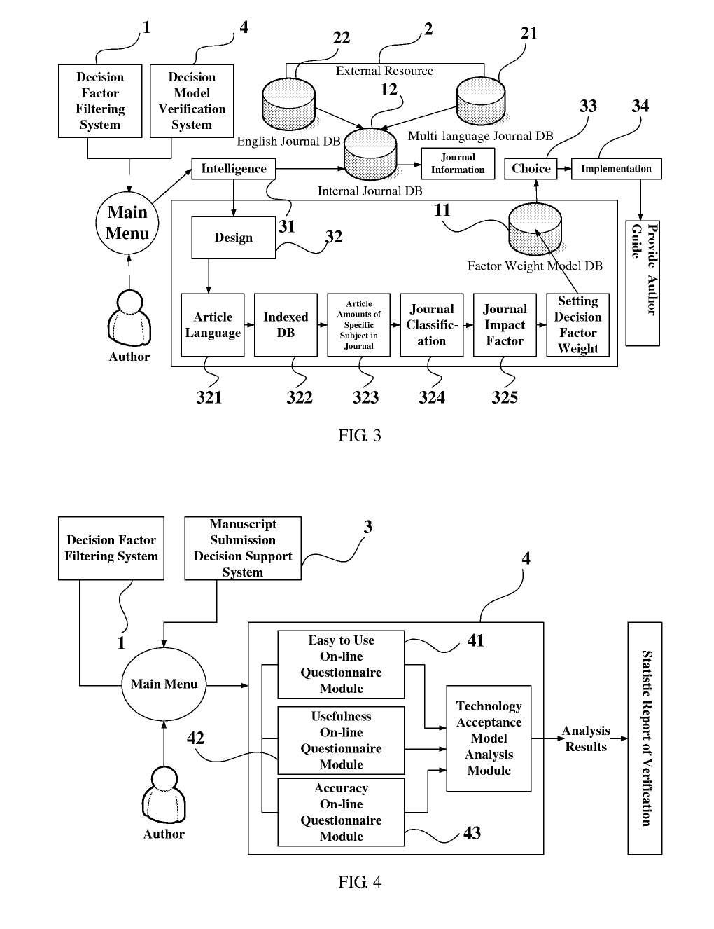

First, please refer to the FIG. 1. It is for the whole sketch map of the Journal Manuscript Submission Decision Support System. This system includes:

Decision Factor Filtering System (1): Basic Decision Factor On-line Questionnaire Module (13) and AHP Decision Factor On-line Questionnaire Module (14) are two major parts in Decision Factor Filter System. Through Critical Decision Factor Weight Calculation Module to proceed with statistics analysis, the decision factor weight can be stored at the Factor Weight Model Data Base (11). Decision Factor Filtering System is at the early stage. In this stage, author profile and preferences would be collected. Related variables such as article language, indexed database, journal impact factor, article amount of specific subject in journal and journal classification would be ranked by authors via questionnaire. After calculating and ranking procedures, the default weight for each factor would be set and saved at the Factor Weight database. The Manuscript Submission Support System would take advantage of factor weight which output from Decision Factor Filtering System. AHP formula and advantage

External Resource (2): External English Journal DB and Multi-Lang Journal DB are the sources to the Internal Journal Database (12). Lots of academic journals are collected in the Internal Journal Database in order to provide rich information and intelligence for the author. The more information author get, the more successful decision author make. Therefore, the internal journal database must store all different kinds of peer-reviewed journals.

Manuscript Submission Decision Support System (3): It connects Decision Factor Filtering System (1) with Internal Journal Database (12). Its purpose is to help author proceed with decision analysis and rank journal priority. Manuscript Submission Decision Support System is the major subsystem in the whole system. Simon proposed four decision steps as the following: 1) Intelligence; 2) Design; 3) Choice; 4) Implementation. In the first stage, decision maker would try to collect the more intelligence the more they can. In the 2^{nd} stage, decision maker would develop alternative solutions and use different analysis models. In the 3^{rd} stage, decision maker would rank and evaluate the alternative solutions in order to choose the best one. In the last stage, decision makers would put their choice into practice. This is a classical decision workflow so that the manuscript submission decision support system was designed to follow this.

In this Manuscript Submission Decision Support System, it also includes four major parts including the Intelligence (31), Design (32), Choice (33) and Implementation (34) system modules. The Manuscript Submission Decision Support System updates its journal information from external journal sources. Connect with Decision Factor Filtering System (1) and Decision Model Verification (4) in order to update the latest decision factor parameter and fine tune the system.

In the Intelligence module (31), it prepares and filters data for Internal Journal DB (12) by parsing external journal sources. It also provides the GUI (Graphic User Interface) to interact with end-users. End Users can survey, browse and search journal information through this module system.

In the Design module (32), the Article Language (321), Indexed DB (322), Article Amounts of Specific Subject in Journal (323), Journal Classification (324) and Journal Impact Factor (325) are the major indicators which combine together in order to calculate the suitable submission target. These indicators were filtered and ranked from Decision Factor Filtering System. The default weights were calculated and saved at the Factor Weight Model DB (11).

In order to get the article amount of specific subject in journal (323) and Journal Classification (324), the text mining algorithm such as TF-IDF was used. Through TF-IDF analysis, we would learn the hot topic for different journal. The TD-IDF was defined and explained as the follow.

The term count in the given document is simply the number of times a given term appears in that document. This count is usually normalized to prevent a bias towards longer documents to give a measure of the importance of the term tᵢ within the particular document dⱼ. The term frequency was defined as follows:

$${tf}_{i , j} = \frac{{n}_{i , j}}{\sum \text{?}} \\ \text{?} \text{indicates text missing or illegible when filed} \qquad ( 1 )$$

where nᵢⱼ is the number of occurrences of the considered term in document dⱼ, and the denominator is the sum of number of occurrences of all terms in document dⱼ. The inverse document frequency is a measure of the general importance of the term (obtained by dividing the number of all documents by the number of documents containing the term, and then taking the logarithm of that quotient).

$${idf}_{i} = log \frac{\vert D \vert}{\text{?}} \\ \text{?} \text{indicates text missing or illegible when filed} \qquad ( 2 )$$

### With

|D|: total number of documents in the corpus

|D:tᵢ εd|: number of documents where the term tᵢ appears (that is nᵢⱼ≠0).

If the term is not in the corpus, this will lead to a division-by-zero. It is therefore common to use 1+|d: tᵢ εd|

### Then

(tf−idf)_{i,j}=tf_{i,j}×idfᵢ (3)

The high weight in tf−idf is reached by a high term frequency and a low document frequency of the term in the whole collection of documents; the weights hence tend to filter out common terms.

Journal Impact Factor (JIF) is from Journal Citation Report (JCR), a product of Thomson ISI (Institute for Scientific Information). JCR provides quantitative tools for evaluating journals. The impact factor is one of these; it is a measure of the frequency with which the “average article” in a journal has been cited in a given period of time. The impact factor for a journal is calculated based on a three-year period, and can be considered to be the average number of times published papers are cited up to two years after publication. For example, the impact factor 2009 for a journal would be calculated as follows:

X=the number of times articles published in 2008-9 were cited in indexed journals during 2010

Y=the number of articles, reviews, proceedings or notes published in 2008-9

Journal Impact factor 2010=X/Y (4)

The ROMC analysis method was used in this research too. This method was proposed by Sprange and Carlson, was used to assist with decision-making from four aspects: (1) Representation, (2) Operation, (3) Memory Aid and (4) Control Mechanisms. To the end-users, Decision Support System should provide the following functions. First, pictures are helpful to make the decision concept clearly. It also helps human beings to communicate with computers. Second, Decision Support System can compute input parameters obtained from user interfaces. Third, Memory Aid is needed in order to store data generated from presentation and operation steps. Fourth, end-users can control and operate the system. In this research, we tried to map Journal Manuscript Submission Decision Support System to ROMC and Simon's Decision Model. See Table 1 for more details. The ROMC matrix was built and based on Simon's decision model. The detailed ROMC matrix mapped by Journal Manuscript Submission Decision Support System was described as below.

### 1) Step I: Intelligence—Browse

For the intelligence mode in the Journal Manuscript Submission Decision Support System, ROMC is described as follows: Presentation (R): The user interface to accept query and then display query results. Operation (O): Integrate different databases and filter out results to match query. Memory Aids (M): Store journal metadata elements and Journal Impact Factor (JIF). Control Mechanism (C): Browse journal and set JIF range.

### 2) Step II: Design—Compare Journals and Provide Feasible Solutions.

(R): List the matched journals after self-evaluation factor and risk factor were calculated. This is the initial feasible solution. (O): The list, adjust and filter operations. (M): Save calculation results. (C): End-users gain control over inputting self-evaluation and risk factors.

### 3) Step III: Choice—Decide on the Target Journals.

(R): The major difference between Step III and Step II is the scoring. In this step, the journal ranking list would be produced by calculating subject code, JIF and paper quantities. This will be helpful in determining suitable targets or solutions. (O): Based on Formula 6, three parameters, which are code distance, JIF and paper quantities are calculated by Journal Manuscript Submission Support System. (M): Store weights for further ranking process. (C): Provide subject's codebook for end-users to choose and let them input article impact factor. In Step III, two types of scoring models were proposed in this study. The Type I model computes the sum of the weights of decision items, as shown in Formula 5. In Sᵣ₁, L is the type of language. N is the amount on the related topic which has been published; V is the average response time. As the value of Sᵣ₁ increases, the journal becomes more suitable for submission. W is the variable's weight. Its default value was from Decision Factor Filtering System. End Users can adjust default weight according to their preferences. The Type II model also uses the weight calculation method, as shown in Formula 6. In Sᵣ₂, F is the Journal Impact Factor and N is the subject code; I in F is the self-evaluated impact factor which we also call the paper impact factor. This factor is equal to the journal impact factor. J in F is the journal impact factor; E in N is the journal's name; C is the thesis title; and E and C are encoded by a codebook, such as Table 1. The larger the value of Sᵣ₂, the more suitable the journal is for authors to submit a particular paper.

$$\begin{matrix}{S}_{r 1} = {W}_{l} L + {W}_{k} N + {W}_{m} T + {W}_{p} V & ( 5 ) \\ {S}_{r 2} = {log}_{e} Q + {W}_{p} F + {W}_{q} N \\ F = \{ \begin{matrix}\frac{1}{\vert I - J \vert} & if I \neq J \\ 1.5 & otherwise I = J\end{matrix} \\ N = \{ \begin{matrix}\frac{1}{\vert E - C \vert} & if E \neq C \\ 1.5 & otherwise E = C\end{matrix} & ( 6 )\end{matrix}$$

TABLE 1
Map Journal Manuscript Submission Decision Support System to Matrix of ROMC.

| | Representation | Operation | Memory Aids | Control |
|---|---|---|---|---|
| Intelligence | 1. Journal | 1. Query and filter | 1. Journal metadata | 1. Browse Journal |
| | query screen. | journal. | elements database. | information. |
| | 2. Display | 2. Integrate External | 2. Journal impact factor | 2. Filter Journal |
| | query results. | Journal Database. | database. | Impact Factor. |
| Design | 1. Feasible | 1. Journal list | 1. Store risk factors. | 1. Input self- |
| | solution and | operation. | 2. Feasible solution. | evaluation factor. |
| | Journal Lists. | 2. Fine tune JIF. | | 2. Input fine-tune |
| | 2. List Journals | 3. Journal filtering. | | factor. |
| | which are fit to | | | 3. Input risk factor. |
| | self-evaluation | | | |
| | results. | | | |
| Choice | 1. The journal | 1. Calculation for JIF, | 1. Store scores. | 1. Select subject |
| | ranking lists | Quantity and Code. | 2. Journal ranking list. | code. |
| | after scoring. | 2. Rank journals and | | 2. Input journal |
| | | list scores. | | impact factor. |

Decision Model Verification System (4): It is used to verify and update the decision factor weight stored in the Factor Weight Model DB (11) continuously.

TAM (Technology Acceptance Model) is one of the famous theories in the Management Information System filed. It was proposed by DAVIS in 1989. Both easy-to-use and usefulness are the most important factors to measure and determine software acceptance. We modify the measurement models and encapsulate them by software system. In the Decision Model Verification System, three sub-modules are included in the Technology Acceptance Model Analysis module. They are 1) Easy-to-Use online questionnaire module (41) 2) Usefulness on-line questionnaire module (42) and 3) Accuracy online questionnaire module (43). Statistic report is generated in order to verify the decision factor and decision model in the Manuscript Submission Decision Support System and Decision Factor Filtering System. This is the while loop procedure. If the result is poor, the decision factor or model would be changed in order to find the better factors or calculation models. We hope to make the Manuscript Submission Decision Support System can reduce author's cost and time to find the suitable journal effectively. Decrease the reject rate and turnaround time between authors and journal.

In this research and development, the new manuscript submission decision support method and system are proposed and implemented. There are no similar patents which unveil the similar techniques. It is accordance to the patent regulation.

What is claimed is:

1. A method of filtering journal manuscript submission decision factors, comprising:
collect and analyze decision factors by online questionnaire. Through further data analysis, the decision factor is calculated and stored at the factor weight database.

2. The method of claim 1, wherein the online questionnaire to collect and rank manuscript submission decision factors by the descriptive statistics and AHP (Analytic Hierarchy Process) question and analysis.

3. A method of suggesting author to submit manuscript to the suitable journal, comprising:
Take full advantage of decision factor weights generated from Decision Factor Filtering System. After combining with external journal sources, it can generate the journal ranked list which help author to make the better decision to submit manuscript. There are four steps including intelligence, design, choice and implementation. 1) Intelligence: the system provides authors with browsing, searching and collecting journal information. 2) Design: let authors can use default or customized decision factor weights to rank journals. 3) Choice: system generates and provides alternative solutions to let author to choose. 4) Implementation: the system provides journal website address, journal introduction and author guide to help authors to complete their manuscript submission.

4. The method of claim 3, wherein preparing the internal journal database by parsing external multi-language journal website and journal database. System can provide journal intelligence for authors to browse and search.

5. The method of claim 3, wherein the decision factors includes article language, indexed database, article amounts of the specific subject journal, journal classification and journal impact factor.

6. The method of claim 5, wherein the decision factors have default weights which calculate from questionnaire.

7. The method of claim 5, wherein the decision factors which users can setup and adjust their every preferred decision factor weights.

8. The method of claim 3, wherein the candidate journal ranking list can be generated and provided according to users' preferences and situations.

9. The method of claim 3, wherein the implementation information includes the author guides, reviewer guide, editorial board and journal audience scope, would be provided according to authors' choices.

10. A method of verifying method and system, comprising:
One Decision Model Verification System to verify the decision factors and decision models. In order to evaluate and polish decision factors, models and manuscript submission decision support system, it can verity them regularly. This verification process is based on the Technology Acceptance Model.

11. The method of claim 10, wherein the verification process of Technology Acceptance Model includes the easy-to-use, usefulness and accuracy on-line questionnaires.
